(19) United States
(12) Patent Application Publication
(10) Pub. No.: US 2024/0295333 A1
(43) Pub. Date: Sep. 5, 2024

(54) PORTABLE AIR PURIFICATION SYSTEM AND STACKING ARRANGEMENT

(71) Applicant: Festool GmbH, Wendlingen (DE)

(72) Inventors: Markus BARABEISCH, Vöhringen (DE); Thorsten MÜLLER, Pforzheim (DE); Tobias WARTH, Winnenden (DE)

(21) Appl. No.: 18/590,340

(22) Filed: Feb. 28, 2024

(30) Foreign Application Priority Data
Mar. 1, 2023 (EP) 23159411.0

(51) Int. Cl. F24F 8/10

(52) U.S. Cl. CPC F24F 8/10; F24F 2221/12; F24F 2221/36

(57) ABSTRACT

A portable air purification system including a housing with a bottom wall, a top wall and side walls extending between the bottom wall and the top wall, which side walls surround a receiving space. In the receiving space, a flow channel for receiving an air filter unit is arranged, which extends between an air inlet in a first side wall of the housing and an air outlet in at least one second side wall of the housing, in which the air filter unit includes an air filter and a fan rotatable about an axis of rotation for generating an air flow from the air inlet to the air outlet. A flow-through area of the air inlet is smaller than or equal to a flow-through area of the air outlet and/or the air outlet has at least two air outlet sections which are arranged on at least two different side walls.

This application claims priority to European application 23159411.0 filed Mar. 1, 2023, which is incorporated by reference.

The invention relates to a portable air purification system comprising a housing with a bottom wall, a top wall and side walls extending between the bottom wall and the top wall, which side walls surround a receiving space, in particular a first receiving space, wherein a flow channel for receiving an air filter unit is arranged in the receiving space, in particular the first receiving space, which flow channel extends between an air inlet in a first side wall of the housing and an air outlet in at least one second side wall of the housing, the air filter unit having an air filter and a fan which can rotate about an axis of rotation for generating an air flow from the air inlet to the air outlet. The side walls comprise the first side wall and the at least one second side wall. The portable air purification system may also be referred to as portable air cleaning system.

Portable air purification systems for use on construction sites and in the craft sector are generally known from the prior art. These are generally used to extract polluted or dusty air from a sealed working space and release it filtered into the environment via a pipe. In this way, a negative pressure is created within the working space, which prevents contaminated or dusty air from entering rooms or areas adjacent to the working space. For example, DE202011050155U1 describes a filter device equipped with transport rollers for filtering room air for renovation work in buildings. A transportable or mobile filter device for filtering a paint mist is known, for example, from DE202014010481U1.

### SUMMARY OF THE INVENTION

One object of the invention is to provide a portable air purification system for use in the craft sector. In particular, the portable air purification system should be suitable for recirculating air operation in closed rooms. Preferably, simple transportation and quick assembly and disassembly should also be possible.

The object is solved by a portable air purification system according to claim 1. The portable air purification system has an flow-through area of the air inlet, which is smaller than an flow-through area of the air outlet. As a result, the speed of the air leaving the air outlet can be reduced so that no disturbing draught is created. In particular, a maximum flow velocity at the air outlet, also referred to as discharge velocity, of one meter per second, for example, can be achieved in this way without having to limit the air flow rate due to the relatively low discharge velocity. This is a great advantage, especially in applications that are designed to filter the room air by circulation. In this way, people present in the room are not affected by high discharge velocities. In addition, unnecessary swirling up of dust and dirt is avoided. The areas of the air inlet and the air outlet refer in particular to the areas through which the air flows. The area through which the air flows can consist of several partial areas that are separated from each other by a grid structure. These can be designed in such a way that a particularly uniform and/or diffuse flow from the air outlet is achieved.

Advantageously, the flow-through area of the air outlet is at least 20%, preferably at least 50%, particularly preferably at least 100% larger than the flow-through area of the air inlet.

The side walls of the housing delimit the receiving space, in particular the first receiving space, respectively at least partially to a side of the housing. Inside the housing, the receiving space, in particular the first receiving space, is bounded by walls surrounding the flow channel. The flow channel is therefore accommodated in the receiving space, but is not part of the receiving space.

The side walls comprise lateral side wall sections, a rear side wall section and a front side wall section. The side wall sections extend between the rear side wall section and the front side wall section. The lateral side wall sections are understood to be the (lateral) narrow sides of the housing, whereas the rear and front side wall sections are the sides that are each larger than the lateral side wall sections. A horizontal extension of the housing along a lateral side wall section is therefore less than a horizontal extension along the rear or front side wall section. A front side is therefore formed at least partially by the front side wall section, and a rear side is formed at least partially by the rear side wall section.

The first side wall is advantageously a side wall of the housing that is different from the second side wall.

The flow channel is bounded radially on the outside by a flow channel structure 42, at least in an axial section along the axis of rotation R. The flow channel structure can, for example, comprise a collector, a diffuser and/or a flow guide element.

The housing can advantageously be designed as a stackable transport box, in particular as a system box. The horizontal dimensions of a system box are fixedly defined so that the system box is compatible with other system boxes of the same system.

In order to design the portable air purification system in such a way that it can be coupled to another system box, the portable air purification system must be dimensioned according to the horizontal dimensions—i.e. the floor plan-of the other system box. A system box is therefore characterized by the fact that it has the same dimensions in at least two dimensions, for example length and width, as another transport box from the same system and can be stacked and coupled to it in a vertically tension-proof manner.

According to the invention, it may be provided that the air inlet and the air outlet of the portable air purification system are arranged on opposite side walls of the housing. Additionally or alternatively, it may be provided that the first side wall is arranged opposite one of the second side walls in the direction of the axis of rotation. Additionally or alternatively, it may be provided that the air outlet or a section of the air outlet is arranged on a side wall opposite the first side wall, preferably in the direction of the axis of rotation. In this way, it is also possible to operate the portable air purification system when it forms part of a stack, for example of system boxes.

A variant according to the invention provides that the air outlet has at least two air outlet sections which are arranged on at least two different side walls, in particular side walls which are different from the first side wall, wherein the at least two air outlet sections are arranged on adjacent side walls and/or opposite side walls. In this way, the flow area of the air outlet can be maximized without having to change the dimensions of the housing. This is particularly advantageous with regard to easy transportability and placement in a stack of system boxes.

A particularly preferred variant according to the invention provides that the at least two air outlet sections are arranged on three side walls, which are in particular different from the first side wall. In this way, the surface area of the air outlet can be maximized, since the air outlet extends at least in some areas over three of the four side walls of the housing. In addition, this also creates a non-directional and therefore diffuse air flow of the air emerging from the air outlet, which contributes to a pleasant working environment.

The fan comprises, for example, an impeller that is driven by a motor, whereby the impeller has an impeller inlet for drawing in air and an impeller outlet for discharging the drawn-in air.

For example, a radial fan can be used as the fan, the impeller outlet of which is oriented transversely to the axis of rotation. In this case, it is particularly advantageous that the air outlet or one of the air outlet sections is formed by at least one radial air outlet, which is arranged on at least one side wall extending in the direction of the axis of rotation. It is particularly advantageous if the radial air outlet has two air outlet sections which are arranged on opposite sides, for example on side walls arranged adjacent to the first side wall.

Advantageously, the radial air outlet is arranged in a side wall section of the side wall or side walls arranged adjacent to the first side wall, the side wall section facing away from the first side wall, so that a direct outflow from the radial fan can take place in the direction of the radial air outlets.

Advantageously, the impeller outlet is completely covered by the radial air outlet in the direction along the axis of rotation and/or the impeller outlet is completely covered by the radial air outlet in the vertical direction. This means that the air flowing out of the impeller outlet can at least partially flow out of the radial air outlets without further flow deflection.

Advantageously, the fan is arranged in the flow channel downstream of the air filter, in particular the first and second air filters.

In addition, an axial air outlet can also be provided, which extends transversely to the axis of rotation of the fan and serves to increase the flow area of the air outlet. Advantageously, the axial air outlet is arranged opposite the first side wall and/or the air inlet. The radial fan therefore draws in the air and blows it out again with particularly low pressure losses due to the low flow deflection.

It is particularly preferred that a main flow direction of the flow channel arranged in the housing runs along the longer of the two horizontal dimensions of the housing.

Particularly preferably, the first side wall is arranged on one of the lateral side wall sections, the second side walls comprise the lateral side wall section opposite the first side wall, the front side wall section and the rear side wall section and/or the axis of rotation of the fan extends along the front side wall section and/or the rear side wall section.

Furthermore, a second receiving space, different from the first receiving space and the flow channel, can be provided in the housing. In one variant, the first and second receiving spaces are spatially separated from each other, for example by a partition wall, in particular an intermediate floor. Advantageously, the first receiving space is sealed off from the second receiving space, in particular sealed off airtight. For example, the intermediate floor can be provided in the housing, which divides the receiving space into the first receiving space for accommodating the air filter unit and a second receiving space. In particular, the air filter unit is completely accommodated in the first receiving space.

The intermediate floor can be aligned parallel to the bottom wall and/or the top wall. In an advantageous embodiment of the housing, the intermediate floor is integral with the housing.

Advantageously, the housing has an access via which at least a part of the receiving space, for example the first or the second receiving space, is accessible, the access preferably comprising a lid and/or a drawer.

The lid closes a housing opening bordered by the, in particular all, side walls and/or closes the receiving space, in particular the second receiving space, to the top. The lid can, for example, have a collar projecting vertically from the top wall, so that a partial volume of the receiving space, in particular the second receiving space, is surrounded by the lid.

In one variant, the lid comprises the top wall at least partially, advantageously completely. The receiving space, in particular the second receiving space, can for example be closed from above or upwards by means of the lid, so that the lid in its closed position delimits the second receiving space at the top. The lid thus opens upwards and/or is rotatably and/or hingedly mounted on at least one of the side walls by means of at least one lid hinge.

The drawer, if present, can be pulled out of a drawer opening of the side walls. Advantageously, a drawer wall forms part of the side wall, so that the drawer closes the drawer opening when the drawer is pushed in.

In the variant in which the intermediate floor is arranged in the housing, the second receiving space is accessible through the open access, in particular the lid and/or the drawer, and/or is only accessible when the access is open. In other words, the first receiving space is not accessible via the access.

The drawer thus forms a part of one of the side walls in order to close the second receiving space, wherein the drawer is preferably extractable from the second receiving space and/or insertable into the second receiving space.

In one variant, the drawer forms a wall region of the side wall.

The embodiment of the portable air purification system explained below is a preferred embodiment of the aforementioned portable air purification system, but is also an independent invention per se in connection with the features mentioned at the beginning or the features of the preamble of claim 1.

The housing of the portable air purification system may comprise a first housing part and a second housing part, which together contain and/or surround the receiving space, in particular the first receiving space. The first housing part and the second housing part are thus arranged together along a housing separation in order to form two housing shells surrounding the (first) receiving space. In this way, the air filter unit can be easily installed in one of the housing parts during assembly and the two housing parts can then be joined together. This is particularly advantageous if the housing comprises the second receiving space.

In a variant according to the invention, the housing separation separates the housing into a first lower housing part and a second lower housing part. Thus, the first housing part can be the first lower housing part and the second housing part can be the second lower housing part. In this case, the first lower housing part comprises the bottom wall and the second lower housing part is arranged on the side of the first lower housing part facing away from the bottom wall. In the variant in which the housing has the intermediate floor, the second lower housing part therefore comprises the intermediate floor. For example, the drawer is then arranged in the second lower housing part and/or the lid is mounted on the second lower housing part so as to be rotatable and/or hinged by means of at least one lid hinge.

In an alternative variant according to the invention, it may be provided that the housing separation extends vertically through the housing, so that the first and second housing parts each partially comprise the intermediate floor and the bottom wall. Thus, the first and second housing parts form a left and a right housing part. The left and right housing parts at least partially surround the second receiving space. The second receiving space can, for example, be closed from above or upwards by means of the lid, so that the lid in its closed position delimits the second receiving space together with the left and right housing parts.

According to the invention, it may be provided that a support structure is provided in the housing, which support structure is structurally connected to the housing and is suitable for supporting the air filter unit. In particular, the support structure is a structure connected to the housing but not integral with the housing.

Advantageously, the support structure mechanically connects the first and second housing parts to each other or the first and second housing parts are fixed to each other by means of the support structure. In particular, the support structure is detachably connected, for example screwed, to the first housing part and/or the second housing part.

Advantageously, the support structure accommodates the flow channel structure or the flow channel structure forms the support structure.

In one variant, the air purification system comprises a mains cable which can optionally be guided out of a cable receiving space through an opening arranged in the housing, in particular in the side wall, and/or is guided through the opening during operation and is accommodated in the cable receiving space during transportation or can be accommodated in the cable receiving space. The opening is advantageously arranged in the area of a separating area formed by the access.

The cable receiving space can be arranged inside the second receiving space or be enclosed by it. The cable storage space can, for example, be formed by the drawer.

For example, the opening is located in the area of the housing opening that can be closed by the lid, i.e. in the separating area between the lid and the side walls. The opening is therefore limited by one of the side walls and/or the lid.

For example, the opening can be arranged in the drawer wall.

The air purification system can also have a coupling interface with which a releasable, vertically tension-proof coupling to one or more system boxes can be established, so that the air purification system can form a vertical stack together with the one or more system boxes. The coupling interface is in particular a mechanical coupling interface.

By way of example, the coupling interface comprises a lower coupling interface, which provides a lower releasable, vertically tension-proof coupling to a lower system box, and/or an upper coupling interface, which provides an upper releasable, vertically tension-proof coupling to an upper system box.

The coupling interface expediently comprises several coupling sections. The coupling sections expediently comprise one or more fixed coupling sections, for example one or more coupling recesses and/or one or more coupling protrusions. Expediently, the coupling interface further comprises at least one (exemplarily exactly one) movably mounted coupling section, for example a coupling latch or a coupling pawl. The coupling latch is designed in particular as a rotary latch, for example as a T-shaped rotary latch.

The upper coupling interface comprises, by way of example, several upper coupling sections, which are arranged in particular on the top wall. Exemplarily, the upper coupling sections comprise coupling recesses, which are arranged in particular on the top wall. Expediently, the upper coupling sections comprise a rotary latch, which is arranged in particular at the top of one of the side walls.

By way of example, the lower coupling interface comprises several lower coupling sections, which are arranged in particular on the bottom wall. Exemplarily, the lower coupling sections comprise lower coupling protrusions, which are arranged in particular on the bottom wall and are designed, for example, as feet. Expediently, the lower coupling sections comprise a front coupling projection, which is arranged in particular on the same side wall as the rotary latch.

The coupling interface is expediently designed in such a way that it can be coupled to an identical coupling interface; in particular, the lower coupling sections of the coupling interface can be coupled to upper coupling sections of an identical coupling interface. For example, the lower coupling protrusions of the coupling interface can be brought into engagement with coupling recesses of an identical coupling interface and/or the front coupling protrusion can be brought into engagement with a rotary latch of the identical coupling interface and/or the rotary latch can be brought into engagement with a front coupling protrusion of the identical coupling interface.

Furthermore, the invention is directed to a stacking arrangement comprising a portable air purification system and a lower system box and/or an upper system box, wherein the air purification system is placed on the lower system box and/or the upper system box is placed on the air purification system, so that the air purification system, the lower system box and/or the upper system box form a vertical stack, and wherein a coupling interface comprises a lower coupling interface which provides a lower releasable, vertically tension-proof coupling to the lower system box and/or an upper coupling interface which provides an upper releasable, vertically tension-proof coupling to the upper system box.

### BRIEF DESCRIPTION OF THE DRAWINGS

Further exemplary details and exemplary embodiments are explained below with reference to the figures. Thereby shows

FIG. 1 a portable air purification system according to the invention, viewed diagonally from above and the front,

FIG. 2 the air purification system from FIG. 1 viewed diagonally from above and the rear,

FIG. 3 the air purification system from FIG. 1 viewed obliquely from below and the front,

FIG. 4 an exploded view of the air purification system from FIG. 1

FIG. 5 a longitudinal section through the air purification system shown in FIG. 1,

FIG. 6 the air purification system from FIG. 1 with an alternative motor mount,

FIG. 7 a portable air purification system according to the invention in a variant with axial fan,

FIG. 8 an air purification system according to the invention with open lid,

FIG. 9 an air purification system according to the invention with a cable storage space,

FIG. 10 an air purification system according to the invention with an alternative routing of the mains cable out of the cable storage space,

FIG. 11 an air purification system with a cable storage space according to a version with a drawer,

FIG. 12 a stacking arrangement comprising the air purification system from FIG. 1 as well as a lower system box and an upper system box,

FIG. 13 a section through a coupling section of a coupling interface,

FIG. 14 a sectional view of a rotary latch of the coupling interface in the coupled state,

FIG. 15 an air purification system according to the invention with open filter access,

FIG. 16 an air purification system according to the invention with an open alternative filter access,

FIG. 17A, B a battery interface of a portable air purification system,

FIG. 18 an air purification system according to the invention according to an alternative embodiment from the front left at an angle,

FIG. 19 the air purification system according to FIG. 17 from an oblique right front view.

### DETAILED DESCRIPTION OF THE INVENTION

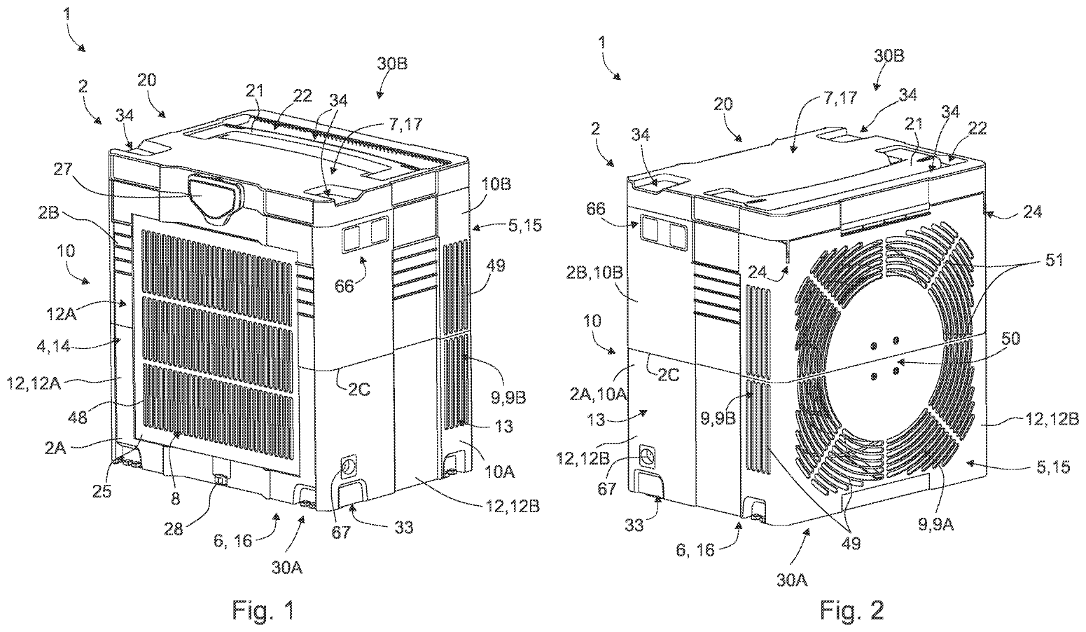

FIGS. 1 to 6 show a first embodiment of a portable air purification system 1, the housing 2 of which is designed as a system box. The housing has side walls 12, which extend in a vertical direction between a bottom side 6 and a top side 7 of the housing 2. The bottom side 6 of the housing 2 is formed by a bottom wall 16 and the top side 7 by a top wall 17, which together with the side walls 12 delimit a receiving space 3.

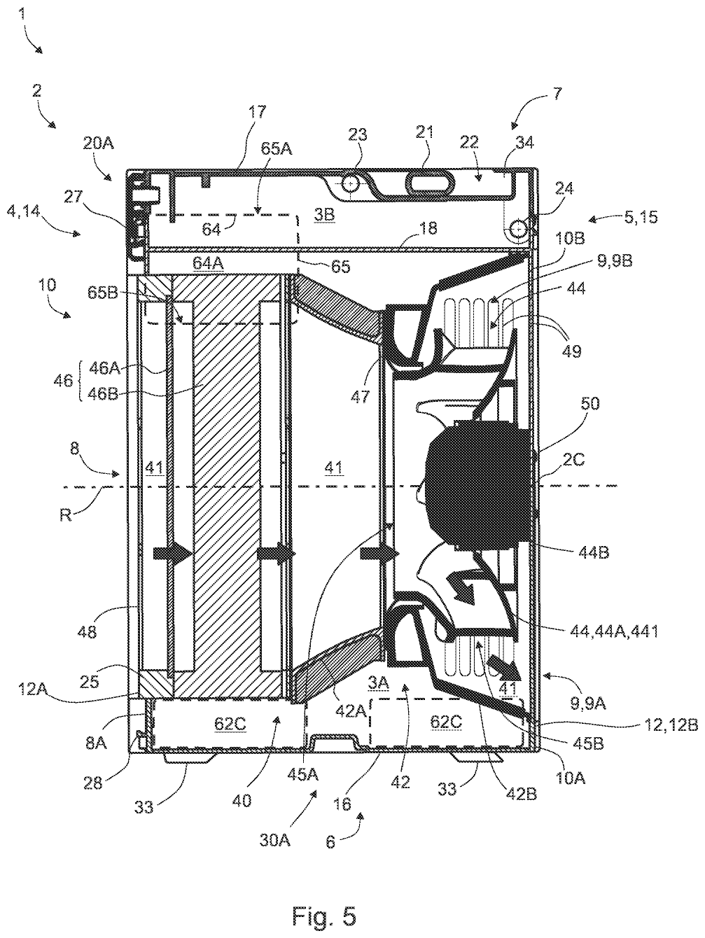

An air filter unit 40 is accommodated in the receiving space 3. The air filter unit has an air filter 46 and a fan 44 rotatable about an axis of rotation R for generating an air flow from the air inlet 8 to the air outlet 9, as shown in FIGS. 4 and 5. The air filter 46 and the fan 44 are arranged in a flow channel 41, which guides the air flow (shown by the black arrows in FIG. 5).

FIG. 5 shows the portable air purification system 1 in a longitudinal section along the axis of rotation R.

An air inlet 8 is arranged on a first side wall 12A of the housing 2. An air outlet 9 is arranged on second side walls 12B of the housing 2.

The air inlet 8 comprises a coarse-meshed inlet grid 48, which is formed, for example, from the same material as the housing 2. Similarly, the air outlet 9 comprises a coarse-meshed outlet grid 49, which is formed, for example, from the same material as the housing 2.

In the present case, the second side walls 12B extend over three sides of the housing 2, which comprise lateral side wall sections 13 and a rear side wall section 15. According to the present example, the front side wall section 14 is the first side wall 12A, while the second side walls 12B comprise the lateral side wall sections 13 and the rear side wall section 15.

The air outlet 9 also extends over three sides of the housing 2, namely over the second side walls 12B, as FIGS. 1 and 2 illustrate. In the present case, the air outlet 9 comprises three air outlet sections, which are formed by an axial air outlet 9A and two radial air outlets 9B. The radial air outlets 9B are arranged on opposite sides of the housing 2. The axial air outlet 9A is arranged opposite the air inlet 8, i.e. opposite the first side wall 12A.

The air inlet 8 extends over a large part of the first side wall 12A, i.e. the front side wall section 14, in the present example over more than 50 percent of the first side surface 12A.

The axial air outlet 9A extends over a large part of the side wall opposite the first side wall 12A, i.e. the rear side wall section 15.

The radial air outlets 9B are arranged on the half of the side walls 12 facing the axial air outlet 9A and extending between the air inlet 8 and the axial air outlet 9A.

The flow-through area of the air outlet 9 is approximately 20% larger than the flow-through area of the air inlet 8. In addition, the arrangement of the air outlet 9 on three different sides of the housing 2 has the effect that an outflow from the air outlet 9 in three directions of the room produces a diffuse flow with a low outflow velocity. This is particularly advantageous when the air purification system is operated close to the floor, as dust and dirt are not whirled up unnecessarily.

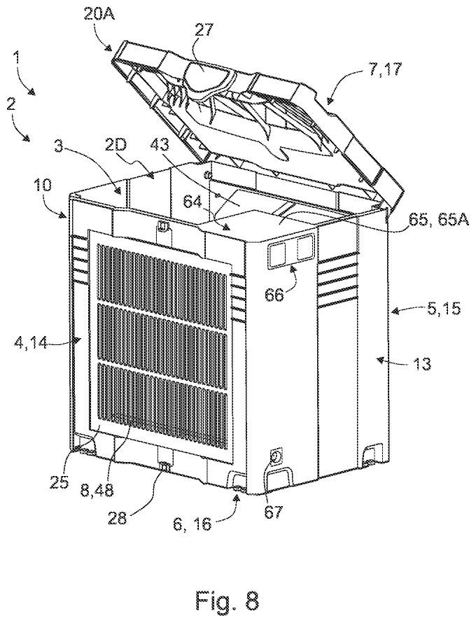

FIGS. 1 and 2 also show that the housing 2 has an access 20 in the form of a lid 20A. In an open position of the access 20, the receiving space 3 is accessible to a user from above through a housing opening 2D, as illustrated for example in FIG. 8. In a closed position of the access 20, the receiving space 3 is not accessible to a user. The lid 20A is hinged to one of the side walls 12, here exemplarily to the rear side wall 15, by means of two lid hinges 24 and can be fixed or locked in the closed position by means of a rotary latch 27, exemplarily arranged on the front side wall 14.

A carrying handle 21 is arranged on the top wall 17. In the folded-in state, the carrying handle 21 is embedded in a carrying handle receptacle 22 of the top wall 17, so that the top of the housing 2 forms a support surface.

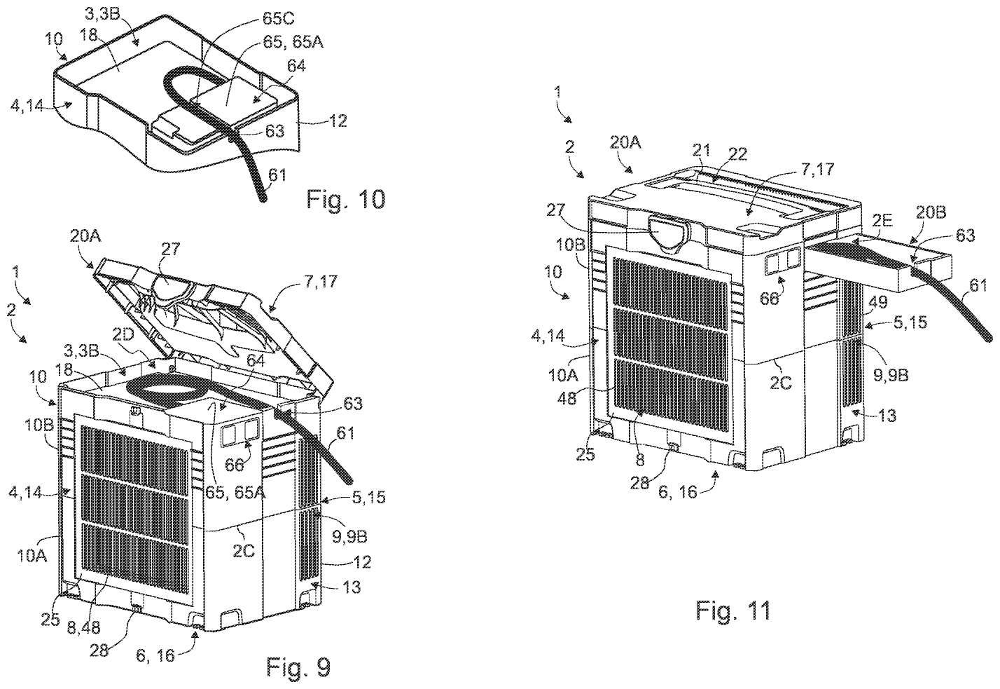

As an example, an intermediate floor 18 is provided in the housing 2, as shown in FIGS. 4, 5, 9 and 10, which divides the receiving space 3 into a first receiving space 3A for receiving the air filter unit 40 and a second receiving space 3B. The intermediate floor 18 is integral with the housing 2. As FIGS. 9 and 10 show, the second receiving space 3B serves as a cable storage space.

The embodiment of the portable air purification system explained below is a preferred embodiment of the aforementioned portable air purification system, but is also an independent invention per se in connection with the features mentioned at the beginning or the features of the preamble of claim 1.

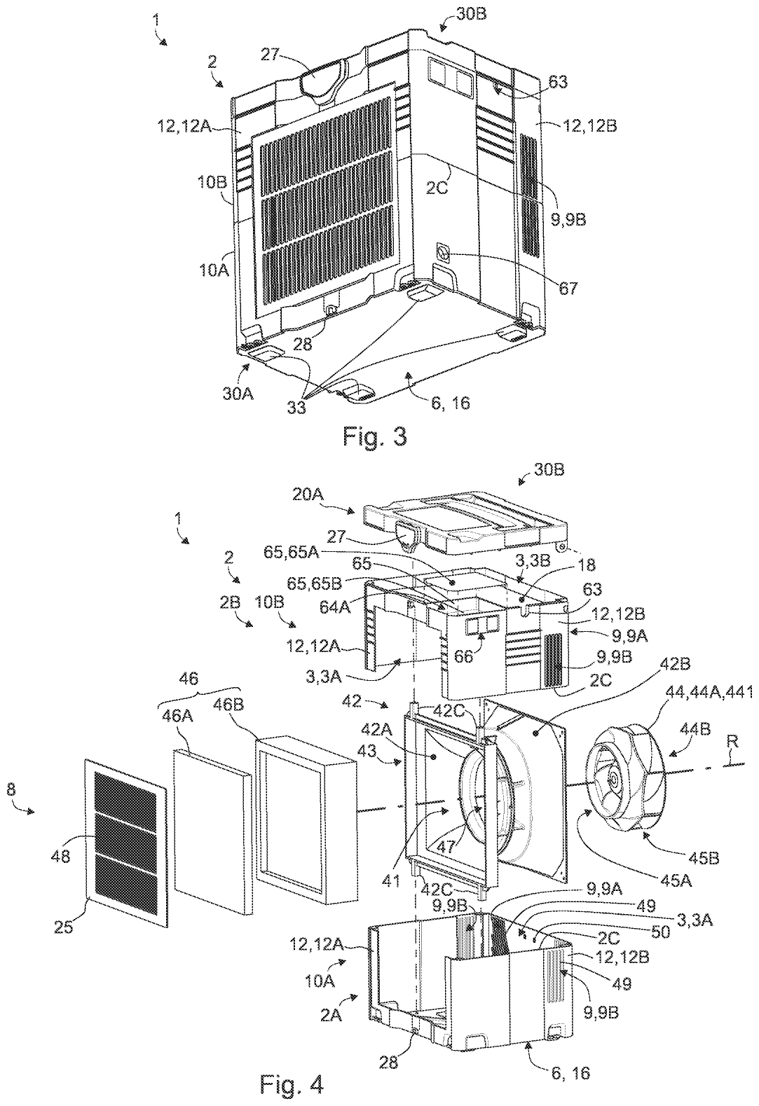

An enclosure 64 enclosing an enclosure receiving space 64A is arranged in the receiving space 3, wherein at least one electronic component for controlling and regulating the air purification system 1 is arranged in the enclosure receiving space 64A. As an example, the enclosure 64 is at least partially integrally formed with the housing 2 and/or with one of the side walls 12 and/or with the intermediate floor 18, as shown, for example, in FIGS. 3, 8 and 9.

For example, the enclosure 64 is arranged in the region of the intermediate floor 18 and/or the intermediate floor 18 is penetrated by the enclosure 64, so that the enclosure receiving space 64A extends both into the first receiving space 3A and into the second receiving space 3B, as shown, for example, in FIG. 5. Alternatively, it may also be provided that the intermediate floor 18 delimits the enclosure receiving space 64A and forms an enclosure wall 65—as shown in FIGS. 4, 9 and 10—for example an enclosure ceiling 65A or an enclosure floor 65B.

The enclosure ceiling 65A is advantageously detachably connected to the lower housing part 10, for example by means of a screw connection indicated in FIG. 4, in order to form an enclosure lid.

The enclosure 64 shown in FIGS. 4 and 9 has two enclosure walls 65 formed integrally with the side walls 12 and two opposing enclosure walls 65. The enclosure walls 65 thus extend vertically from the intermediate floor 18 into the second receiving space 3B to define the enclosure receiving space 64A together with the enclosure ceiling 65A formed as the enclosure lid.

In the enclosure 64 shown in FIG. 10, a circumferential gap extends between the vertically extending enclosure walls 65 of the enclosure 64 and the side walls 12.

In the variant of the air purification system 1 shown in FIG. 8, the enclosure 64 has two enclosure walls 65 formed integrally with the side walls 12 and two opposing enclosure walls 65 which, together with the enclosure ceiling 64A and the enclosure floor 64B, delimit the enclosure receiving space 64A, the first receiving space 3A being accessible via the housing opening 2D.

Furthermore, an operating unit 66 is provided for operating the air purification system 1 by a user. The operating unit 66 comprises operating elements for operating the air purification system 1 by a user and/or display elements for displaying the operating state of the air purification system 1. The operating unit 66 is exemplarily arranged on one of the side walls 12 and delimits the enclosure receiving space 64A outwardly at least in some regions.

The enclosure receiving space 64A is sealed with respect to its surroundings and/or the receiving space 3 surrounding the enclosure 64. Preferably, the operating unit 66 seals the enclosure receiving space 64A from the outside. This is particularly important for applications in the craft sector, for example on construction sites.

The air purification system 1 has an electrical interface 67 for supplying the air purification system 1 with electrical energy. The air purification system 1 can thus be connected to an AC voltage source via the electrical interface 67.

The electrical interface 67 of the first embodiment example disclosed in FIGS. 1 to 3 is a mains cable connection 671 for connecting a mains cable 61 for supplying the air purification system 1 with an electrical voltage. The mains cable 61 can be detachably connected or coupled to the mains cable connection 671.

In the illustration shown in FIG. 9, an alternative variant of supplying the air purification system 1 with an electrical voltage via the mains cable 61 is shown. In other words, an alternative variant of the electrical interface 67 is used in which the mains cable 61 is advantageously connected to the air purification system 1 in a fixed manner, i.e. cannot be detached without tools. The mains cable 61 is routed via the receiving space 3, in particular the second receiving space 3B, into the enclosure receiving space 64A. The mains cable 61 is guided from the outside into the second receiving space 3B through an opening 63 in one of the side walls 12.

In a variant of the enclosure 64 shown in FIG. 10, the enclosure 64 has an enclosure recess 65C, which is arranged in alignment with the opening 63 in order to guide the mains cable 61 out of the receiving space 3 through the enclosure recess 65C and the opening 63.

The enclosure 64 is designed to have at least two feedthroughs, which are designed to guide electrical conductors from the enclosure receiving space 64A into the receiving space 3, wherein it is preferably provided that a first feedthrough guides one or more electrical conductors from the enclosure receiving space 64A into the first receiving space 3A and a second feedthrough guides one or more electrical conductors, in particular the mains cable 61, from the enclosure receiving space 64A into the second receiving space 3B.

During transportation of the air purification system 1, the mains cable 61 is completely accommodated in the receiving space 3, in particular in the second receiving space 3B, without being electrically separated from the air purification unit 1. This has the advantage that the mains cable 61 is firmly connected to the air purification system 1 during transportation without protruding beyond the dimensions of the housing 2 during transportation.

FIG. 11 discloses an alternative design of the access 20 in the form of a drawer 20B, which accommodates the mains cable 61 during transportation of the air purification system 1. The illustration shows the drawer 20B in the pulled-out state. In this case, the opening 63 is formed in a drawer wall so that the mains cable 61 can be led out of the receiving space 3 even when the drawer 20B is pushed in. When the drawer 20B is pushed in, the drawer wall therefore closes a side wall opening 2E, which is connected to the housing 2.

The housing 2 comprises a lower housing part 10, which is formed by the side walls 12 and the bottom wall 16. According to the present embodiment example, the lower housing part 10 has a first lower housing part 10A and a second lower housing part 10B, which lie vertically on top of one another along a housing separation 2C. The first lower housing part 10A comprises the bottom wall 16. The lid 20A is arranged on the second lower housing part 10B.

The air filter 46 has, by way of example, a first filter element 46A, for example a coarse filter or pre-filter, and a second filter element 46B, for example a HEPA filter, which are arranged one behind the other in the flow channel, as shown by way of example in FIGS. 4 and 5.

The fan 44 has an impeller 44A and a motor 44B driving the impeller 44A. The impeller 44A has an impeller inlet 45A for drawing in air and an impeller outlet 45B. In the present example, the fan 44 is designed as a radial fan 441.

The flow channel 41 is bounded by a flow channel structure 42 transverse to the flow direction at least in a section along the flow direction. The flow channel structure 42 thus forms the walls surrounding the flow channel 41 at least in an axial section along the axis of rotation R.

The flow channel structure 42 can, for example, comprise a collector 42A, a diffuser 42B and/or a flow guide element 47.

The collector 42A is arranged between the air filter 46 and the fan 44 and guides the air in the direction of the impeller 44A. The flow guide element 47 is arranged in front of the impeller 44A to homogenize the flow towards the impeller 44A.

The diffuser 42B is arranged in the area of the impeller outlet 45B, which directs the flow emerging from the impeller 44A in the direction of the air outlet 9.

FIG. 5 illustrates that the impeller outlet 45B is completely covered by the radial air outlet 9B along the axis of rotation R. As an example, the radial air outlets 9B have the same axial extension in the direction of the axis of rotation R as the impeller outlet 45B.

FIG. 5 also illustrates that the impeller outlet 45B is completely covered by the radial air outlet 9B in the vertical direction (i.e. in the direction perpendicular to the bottom wall). A vertical extension of the radial air outlet 9B is therefore greater than or equal to a vertical extension of the radial fan 441, i.e. greater than or equal to an outer diameter of the impeller outlet 45B.

The impeller outlet 45B of the radial fan 441 is thus arranged in such a way that the air flowing out of the impeller outlet 45B can flow out of the radial air outlets 9B without further flow deflection.

In the embodiment example shown, an axial air outlet 9A is arranged on the rear side wall section 15 in addition to the radial air outlets 9B.

According to the embodiment example shown in FIG. 5, the fan 44 is attached to the side wall 12 facing away from the air inlet 8, i.e. the rear side wall section 15.

The fan 44 is attached to a motor mount 50, advantageously in front of the motor mount 50 in the direction of flow. As an example, a motor mount holder 51 is provided, which fixes the motor mount 50 relative to the housing. The fan 44 is detachably fastened to the motor mount 50 or the side wall 12, in particular by means of screw elements.

Advantageously, at least two motor mount holders 51 are provided, which extend outwards in a radial direction from the motor mount 50 and/or the axis of rotation R, in particular along the housing separation 2C, as can be seen in FIG. 2.

The motor mount 50 and/or motor mount holder 51 is/are formed integrally with the housing 2 and/or the motor mount 50 and/or the motor mount holder 51 is/are formed by a side wall 12 facing away from the air inlet 8.

In the embodiment example according to FIGS. 4 and 5, the side wall opposite the first side wall forms the motor mount 50 and the motor mount holders 51. In other words, the motor mount 50 and the motor mount holders 51 are integrally formed with the second side wall 12B.

According to an advantageous embodiment, the housing separation 2C, as shown as an example in FIG. 2, extends through at least one of the motor mount holders 51.

The air outlet 9, in particular the axial air outlet 9A, is arranged radially on the outside around the motor mount 50, so that the motor mount 50 forms a fastening section in the side wall 12, in particular opposite the first side wall 12A, and/or the motor mount 50 forms a central section in the air outlet 9.

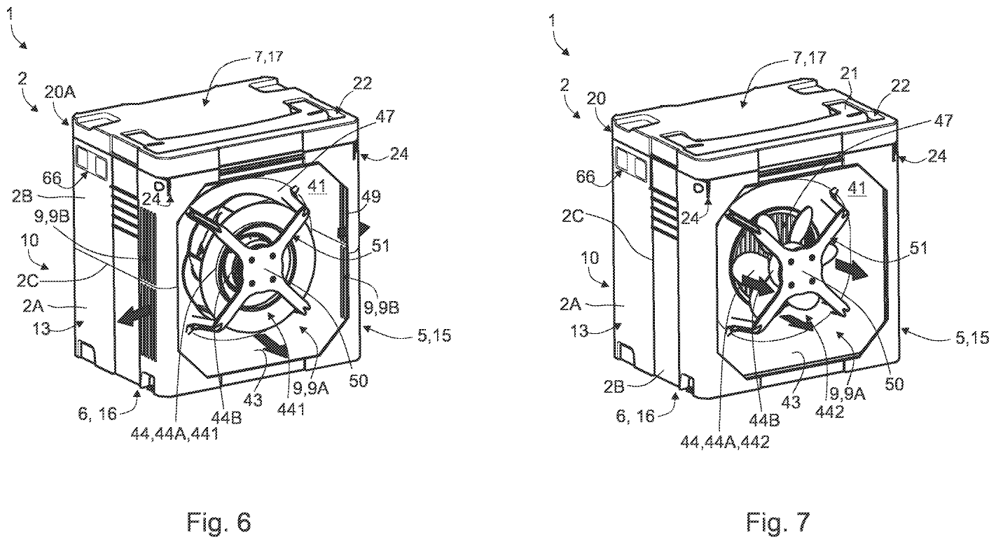

In an alternative embodiment, shown in FIG. 6, the motor mount 50 and the motor mount holder 51 are separate components from the housing 2. As an example, the motor mount holders 51 are formed integrally with the motor mount 50, for example from a metal sheet.

According to the embodiment shown in FIG. 6, the motor mount 51 is fixed to the flow channel structure 42, in particular the flow guide element 47. As a result, the fan 44 can be aligned more precisely in relation to the flow channel structure 42 during assembly due to the shorter tolerance chain. This has a positive effect in terms of fluid mechanics.

In this case, the motor mount 51 is screwed radially to the outside of the flow element 47.

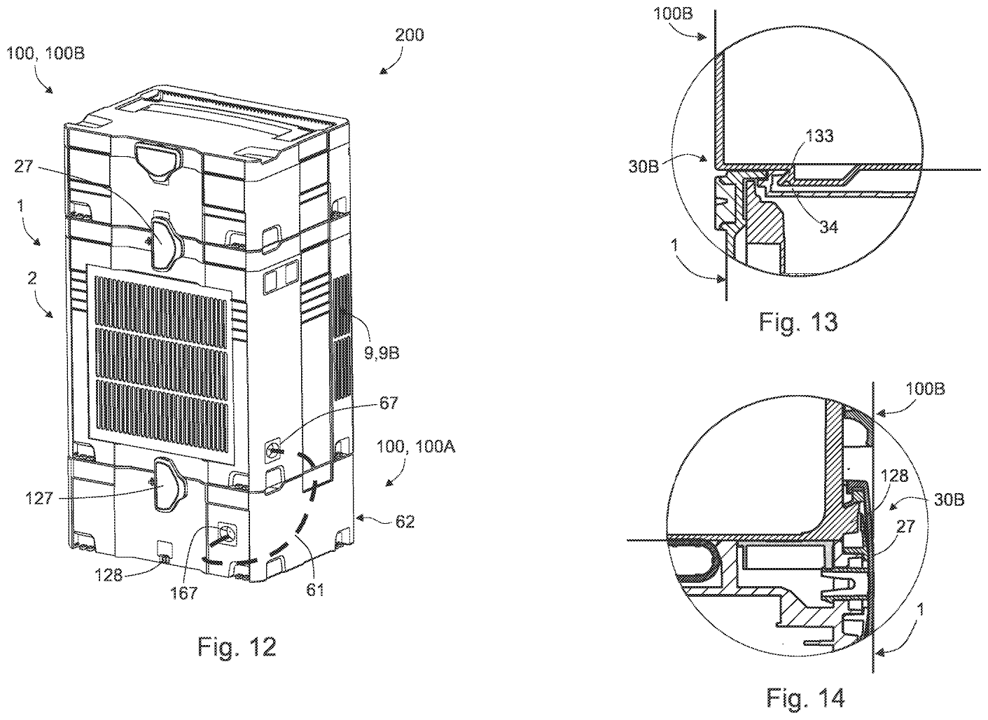

The air purification system 1 also has a coupling interface 30, with which a releasable, vertically tension-proof coupling to one or more system boxes 100 can be produced. The coupling interface 30 can be seen, for example, in FIGS. 1 to 3. The air purification system 1 can form a vertical stack together with the one or more system boxes 100. A stacking arrangement 200 comprising the air purification system 1 and system boxes 100 is shown in FIG. 12.

The coupling interface 30 comprises a lower coupling interface 30A that provides a lower releasable, vertical tension-proof coupling to a lower system box 100A, and an upper coupling interface 30B that provides an upper releasable, vertical tension-proof coupling to an upper system box 100B.

The coupling interface 30 comprises a plurality of coupling sections. The coupling sections expediently comprise one or more fixed coupling sections, for example one or more coupling recesses 33 and/or one or more coupling protrusions 34. Expediently, the coupling interface further comprises at least one (exemplarily exactly one) movably mounted coupling section, for example a coupling latch 27 or a coupling pawl. The coupling latch 27 is designed in particular as a rotary latch, for example as a T-shaped rotary latch.

The upper coupling interface 30B exemplarily comprises several upper coupling sections, which are arranged in particular on the top wall 17. Exemplarily, the upper coupling sections comprise coupling recesses 34, which are arranged in particular on the top wall 17. Expediently, the upper coupling sections comprise a rotary latch 27, which is arranged in particular at the top of one of the side walls 12.

Exemplarily, the lower coupling interface 30A comprises a plurality of lower coupling sections, which are arranged in particular on the bottom wall 16. Exemplarily, the lower coupling sections 30A comprise lower coupling protrusions 33, which are arranged in particular on the bottom wall 16 and are designed, for example, as feet. Expediently, the lower coupling sections 30A comprise a front coupling projection 28, which is arranged in particular on the same side wall 12 as the rotary latch 27.

The coupling interface 30 is expediently designed such that it can be coupled to an identical coupling interface of a system box 100, which is also referred to as system box coupling interface 130.

In FIGS. 13 and 14, the upper coupling section 30B of the coupling interface 30 is coupled to lower system box coupling sections 130A of an upper system box 100B. Here, system box coupling protrusions 133 of system box coupling interface 130 are in engagement with coupling recesses 34 and a front system box coupling protrusion 128 of upper system box 100B is in engagement with coupling latch 27.

Likewise, the lower coupling sections 30A of the coupling interface 30 may be coupled to upper system box coupling sections 130B of a lower system box 100A. Here, the lower coupling protrusions 33 of the coupling interface 30 are in engagement with system box coupling recesses 134 of the lower system box 100A and the front coupling protrusion 28 is in engagement with a system box locking means 127 of the system box 100.

As shown in FIG. 4, the air purification system 1 may include a support structure 43 received within the lower housing 10. The support structure 43 is structurally connected to the lower housing part 10. In particular, the support structure 43 mechanically connects the first and second housing parts 2A, 2B to each other. Thus, the first and second housing parts 2A, 2B are fixed to each other by means of the support structure 43. This is particularly advantageous if the first housing part 2A comprises the first lower housing part 10A and the second housing part 2B comprises the second lower housing part 10B. In this case, the support structure 43 forms a tension-proof connection between the first lower housing part 10A and the second lower housing part 10B.

In the present case, the support structure 43 has screw bosses 42C, with which the support structure 43 is screwed or can be screwed to the first and second lower housing parts 10A, 10B by means of screws. The screw bosses 42C advantageously comprise upper and lower screw bosses. The upper screw bosses serve to connect the support structure to the upper lower housing part 10B. Here, the screws are screwed into the respective upper screw bosses via the second receiving space 3B through the intermediate floor 18. The lower screw bosses are used to connect the support structure 43 to the first lower housing part 10A. For this purpose, screws are screwed from below through the bottom wall 16 into the respective lower screw domes.

In the present case, the flow channel structure 42 forms or comprises the support structure 43.

In this way, the flow channel structure 42 can be introduced into the first lower housing part 10A during assembly and structurally connected to it by the support structure 43, for example—as explained above—screwed to it by means of the screw bosses 42C. The second lower housing part 10B can then be placed on the first lower housing part 10A and connected to the first lower housing part 10A by the support structure 43.

This is particularly advantageous if the air purification system 1 is coupled to one or more system boxes 100 at one of the coupling sections 30A, 30B, since the vertical tensile forces are thus absorbed by the support structure 43.

The embodiment example according to FIGS. 1 to 4 has a filter access 25 on one of the side walls 12. The filter access 25 is a part of the side wall 12 which part at least partially closes a filter access opening 251, so that an air filter 46 is replaceably arranged in the flow channel 41.

The air filter 46 can be removed and/or inserted from the housing 2 through the filter access opening 251, so that it can be replaced or cleaned. As an example, the air filter 46 is pulled out of the flow channel 41 in the direction of the axis of rotation R through the filter access opening 251. In an alternative variant not shown, the air filter 46 is pulled out of the housing 2 transversely to the axis of rotation R.

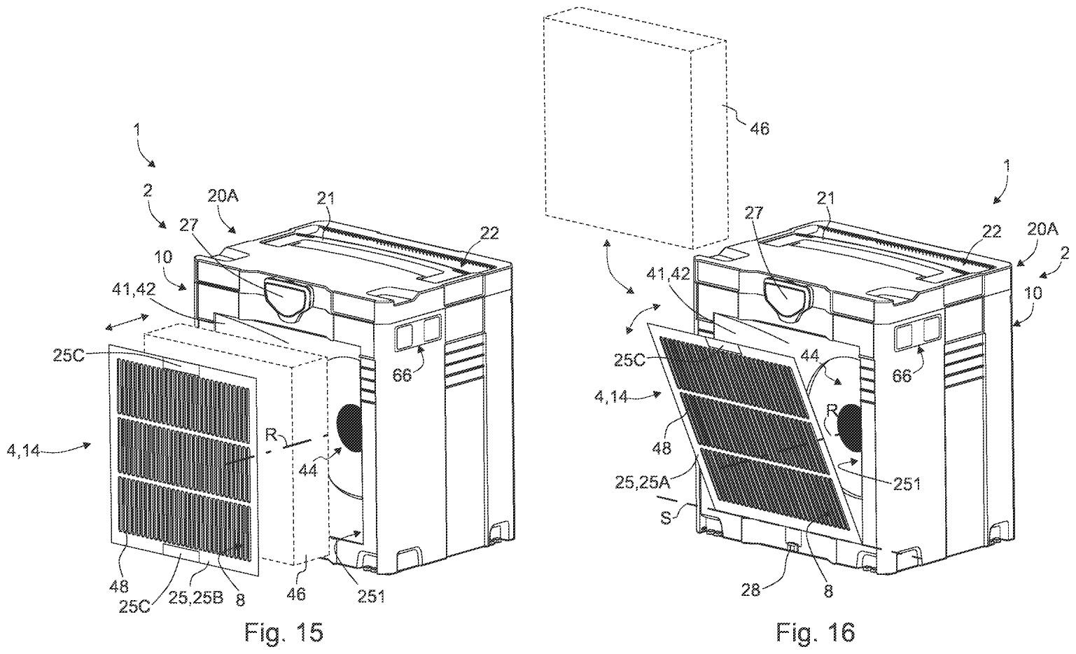

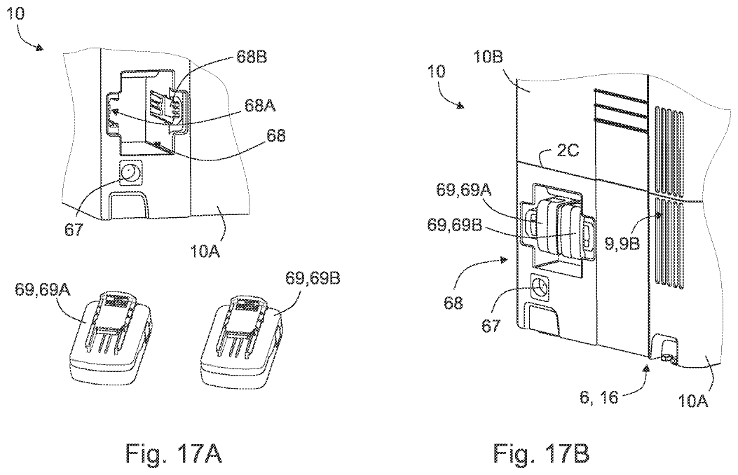

The filter access 25 comprises, for example, an access flap 25A, as shown schematically in FIG. 16, or an access lid 25B, as shown schematically in FIG. 15.

The access flap 25A has a hinge forming a hinge axis S, wherein the access flap 25A is rotatably mounted, by way of example, on a side of one of the side walls 12, which side is facing the bottom wall 17, in order to expose the filter access opening 251. The hinge axis S is thus aligned horizontally in this case. Similarly, the access flap 25A can be designed as a door. In this case, the hinge axis S is aligned vertically and arranged on one of the side walls 12. On its side opposite the hinge axis S, the access flap has an access latch 25C with which the access flap 25A can be locked to the housing 2 in a closed position.

As an example, the access lid 25B is releasably attached to the housing 2 by means of two opposite sides of the access lid 25B so that it can be easily removed from the housing 2 to replace the air filter 46.

Advantageously, the filter access 25 comprises the air inlet 8 at least partially, in the present embodiment example completely.

According to a variant, the air purification system 1 comprises at least one energy storage unit 62C, wherein the at least one energy storage unit 62C is accommodated in the housing 2 and/or is integrated into the housing 2. The energy storage unit 62C is, for example, a rechargeable battery, preferably with a nominal voltage of 18 volts or greater, for example 36 volts.

In one variant, a charging device is provided in the housing 2, with which the at least one energy storage device 62 can be charged via the electrical interface 67.

In addition or as an alternative to the variants described above, the electrical interface 67 can comprise a battery interface 68. The battery interface 68 is designed to provide mechanical and electrical coupling elements for coupling with a battery pack 69 in order to supply the air purification system 1 with electrical energy. The battery interface 68 is exemplarily arranged on the outside of the housing 2, as shown in FIGS. 16A and 16B. Alternatively, it may also be provided that the battery interface 68 is arranged in the second receiving space 3B.

In an alternative, the battery interface 68 comprises at least a first and a second battery interface 68A, 68B and the battery pack 69 comprises at least a first and a second battery pack 69A, 69B.

Preferably, the at least one battery pack 69, 69A, 69B is a battery pack compatible with a power tool. The battery interface 68 is thus designed to accommodate battery packs of a power tool.

FIG. 7 shows a second embodiment of the portable air purification system 1. The design of the air purification system 1 essentially corresponds to the design of the air purification system as shown in FIGS. 1 to 5. In this respect, reference can be made to the above explanations to avoid repetition. Therefore, only the differences are discussed below.

The housing 2 of the air purification system 1 has a lower housing part 10, which comprises a first housing part 2A and a second housing part 2B, which lie against each other along a housing separation 2C. The first and second housing parts 2A, 2B each partially comprise the bottom wall 16. The first housing part 2A thus forms a front housing part and the second housing part 2B forms a rear housing part. The housing separation 2C thus runs in a direction perpendicular to the axis of rotation R.

In the present embodiment example, an axial fan 442 is used instead of the radial fan 441. This means that the air purification system 1 only has one axial air outlet 9A. In principle, it is also conceivable to use radial air outlets 9B when using an axial fan.

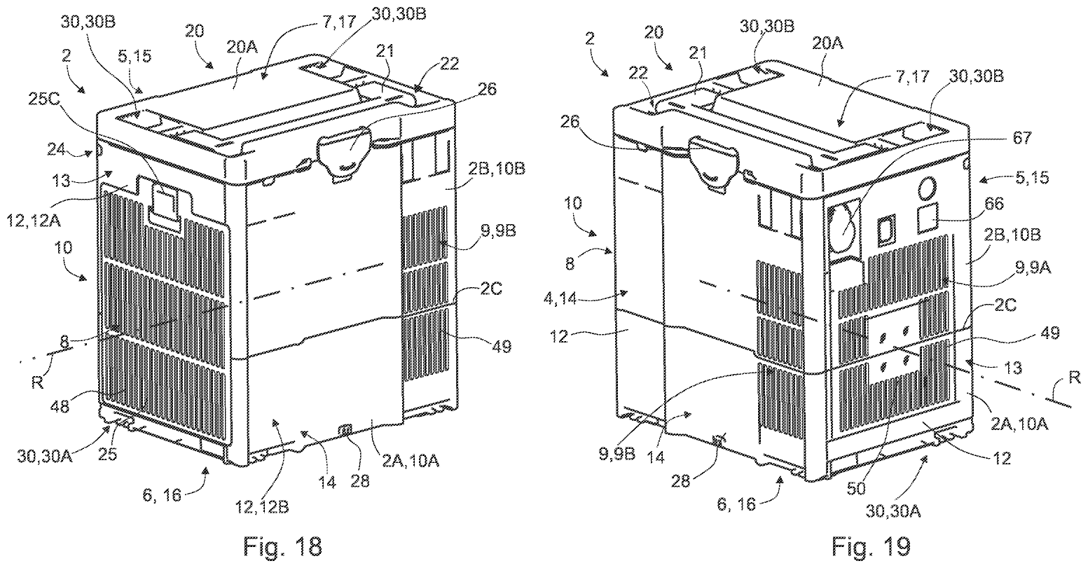

FIGS. 18 and 19 disclose a third embodiment of the portable air purification system 1. The design of the air purification system 1 essentially corresponds to the design of the air purification system as shown in FIGS. 1 to 4. In this respect, reference can be made to the above explanations in order to avoid repetition. Therefore, only the differences are discussed below.

In the present case, the first side wall 12A is arranged on one of the lateral side wall sections 13, while the second side walls 12B comprise the lateral side wall section 13 opposite the first side wall 12A, the front side wall section 14 and the rear side wall section 15.

The rotation axis R of the fan 44 extends along the front side wall section 14 and/or the rear side wall section 15. A main flow direction of the flow channel 41 arranged in the housing 2 thus extends along the longer of the two horizontal dimensions of the housing 2. In this way, it is possible to accommodate a greater filter depth in the receiving space 3, which significantly increases the flow-through area.

1. A portable air purification system comprising a housing with a bottom wall, a top wall and side walls extending between the bottom wall and the top wall, which side walls surround a receiving space, wherein a flow channel for receiving an air filter unit is arranged in the receiving space, which flow channel extends between an air inlet in a first side wall of the housing and an air outlet in at least one second side wall of the housing, wherein the air filter unit comprises an air filter and a fan rotatable about an axis of rotation for generating an air flow from the air inlet to the air outlet,
wherein
a flow-through area of the air inlet is smaller than or equal to a flow-through area of the air outlet and/or
the air outlet has at least two air outlet sections which are arranged on at least two different side walls.

2. The portable air purification system according to claim 1, wherein the at least two air outlet sections are arranged on side walls which are different from the first side wall

3. The portable air purification system according to claim 1, wherein the air inlet and the air outlet are arranged on opposite side walls of the housing and/or
the first side wall is arranged opposite one of the second side walls in the direction of the axis of rotation and/or
the air outlet or a section of the air outlet is arranged on a side wall opposite the first side wall.

4. The portable air purification system according to claim 3, wherein the air outlet or the section of the air outlet is arranged on the side wall opposite the first side wall in the direction of the axis of rotation.

5. The portable air purification system according to claim 1, wherein the at least two air outlet sections are arranged on adjacent side walls and/or opposite side walls.

6. The portable air purification system according to claim 5, wherein the at least two air outlet sections are arranged on three side walls.

7. The portable air purification system according to claim 6, wherein the three side walls are different from the first side wall.

8. The portable air purification system according to claim 5, wherein the air outlet or one of the air outlet sections is formed by an axial air outlet,
which is arranged on a side wall penetrated by the axis of rotation and/or on a side wall opposite the first side wall, and/or
the air outlet or one of the air outlet sections is formed by at least one radial air outlet, which is arranged on at least one side wall extending in the direction of the axis of rotation and/or on at least one of the side walls arranged adjacent to the first side wall.

9. The portable air purification system according to claim 1, wherein two radial air outlets are provided, which are arranged on opposite side walls, and an axial air outlet is provided, which is arranged on a side wall adjacent to the radial air outlets.

10. The portable air purification system according to claim 1, wherein the housing comprises a first housing part and a second housing part, which accommodate the receiving space, and the first housing part and the second housing part are arranged adjacent to each other along a housing separation.

11. The portable air purification system according to claim 10, wherein a support structure is provided in the housing, which is structurally connected to the housing and is suitable for supporting the air filter unit, and wherein the support structure mechanically connects the first and second housing parts to each other or the first and second housing parts are fixed to each other by means of the support structure.

12. The portable air purification system according to claim 10, wherein the first housing part is a first housing lower part and the second housing part is a second housing lower part,
wherein the first housing lower part comprises the bottom wall and the second housing lower part is arranged on the side of the first housing lower part facing away from the bottom wall in order to form the housing separation, and/or
the first housing part and the second housing part form a lower housing part

13. The portable air purification system according to claim 10, wherein the housing separation is arranged in a plane parallel to the bottom wall.

14. The portable air purification system according to claim 1, wherein an intermediate floor is provided in the housing, which divides the receiving space into a first receiving space for receiving the air filter unit and a second receiving space.

15. A portable air purification system comprising a housing with a bottom wall, a top wall and side walls extending between the bottom wall and the top wall, which side walls surround a receiving space, wherein a flow channel for receiving an air filter unit is arranged in the receiving space, which flow channel extends between an air inlet in a first side wall of the housing and an air outlet in at least one second side wall of the housing, wherein the air filter unit comprises an air filter and a fan rotatable about an axis of rotation for generating an air flow from the air inlet to the air outlet, wherein an intermediate floor is provided in the housing, which divides the receiving space into a first receiving space for receiving the air filter unit and a second receiving space.

16. The portable air purification system according to claim 14, wherein the housing has an access via which the second receiving space is accessible.

17. The portable air purification system according to claim 16, wherein the access comprises a lid and/or a drawer

18. The portable air purification system according to claim 14, wherein the air purification system further comprises a mains cable, which can selectively be led out of the second receiving space through an opening arranged in the housing and/or is led through the opening during operation and is received in the second receiving space during transportation or can be received in the second receiving space.

19. The portable air purification system according to claim 18, wherein the opening is arranged in the region of a separating area formed by the lid and the side walls and/or the opening is delimited by one of the side walls and/or the lid.

20. The portable air purification system according to claim 1, wherein the air purification system comprises a coupling interface with which a releasable, vertically tension-proof coupling to one or more system boxes can be established, so that the air purification system can form a vertical stack together with the one or more system boxes.

21. The portable air purification system according to claim 20, wherein the coupling interface comprises a lower coupling interface with which, in a state in which the air purification system is placed on a lower system box, a lower releasable tension-proof coupling to the lower system box can be established, and/or an upper coupling interface, with which, in a state in which an upper system box is placed on the air purification system, an upper releasable, vertically tension-proof coupling to the upper system box can be established.

22. A stacking arrangement, comprising a portable air purification system according to claim 1, as well as a lower system box and/or an upper system box, wherein the air purification system is placed on the lower system box and/or the upper system box is placed on the air purification system, so that the air purification system, the lower system box and/or the upper system box together form a vertical stack, and wherein a coupling interface comprises a lower coupling interface, which provides a lower releasable, vertically tension-proof coupling to the lower system box, and/or an upper coupling interface, which provides an upper releasable, vertically tension-proof coupling to the upper system box.
